(19) United States
(12) Patent Application Publication
(10) Pub. No.: US 2026/0359855 A1
(43) Pub. Date: Nov. 12, 2026

(54) System and Method for Account Holder Identification and Targeting Strategy

(71) Applicant: Mastercard International Incorporated, Purchase, NY (US)

(72) Inventors: Upasana Kalra, Faridabad (IN); Christian Hylander, Schriek (SE); Devesh Bansal, Delhi (IN)

(21) Appl. No.: 19/669,662

(22) Filed: May 6, 2026

Related U.S. Application Data
(60) Provisional application No. 63/802,710, filed on May 9, 2025.

(51) Int. Cl. G06Q 30/0226; G06Q 30/0204; G06Q 50/14

(52) U.S. Cl. CPC G06Q 30/0226; G06Q 30/02043; G06Q 50/14

(57) ABSTRACT

Various implementations described herein are directed to a system and method for enabling or promoting engagement between merchants and consumers based on payment transaction data. The method includes identifying payment transactions associated with a predetermined merchant, merchant category, or industry, and identifying account holders associated with the transactions that exhibit a predetermined transaction activity pattern. Further, the method includes classifying the identified account holders into a plurality of segments based on transaction frequency with a target merchant and generating, for a segment of the plurality of segments, data configured to facilitate engagement between the target merchant and account holders associated with the segment.

### CROSS REFERENCE TO RELATED APPLICATION

This application claims priority to U.S. Provisional Application No. 63/802,710, filed May 9, 2025. The entire disclosure of the above-mentioned application is herein incorporated by reference.

### BACKGROUND

This section is intended to provide background information to facilitate a better understanding of various technologies described herein. As the section’s title implies, this is a discussion of related art. That such art is related in no way implies that it is prior art. The related art may or may not be prior art. It should therefore be understood that the statements in this section are to be read in this light, and not as admissions of prior art.

The airline industry is highly competitive, particularly in the wake of the COVID-19 pandemic. As airline carriers strive to regain market share and boost revenue, airline carriers have experimented with various customer engagement strategies, such as loyalty programs, airline partner-branded cards, and promotional partnerships. However, these efforts have often lacked precision and have been broadly applied across customer segments, resulting in limited effectiveness.

One of the core challenges is the inability to derive actionable insights from available payment transaction data. Although airline carriers may have visibility into ticket purchases, airline carriers often cannot discern underlying customer behaviors or attributes that could inform targeted engagement strategies. Without deeper visibility into how customers spend, travel, and interact with related services, marketing efforts remain diffuse.

### SUMMARY

Described herein are various implementations of a system and method for enabling or promoting engagement between merchants and consumers based on payment transaction data.

Described herein are various implementations of a computer-implemented method executed by at least one processor in communication with a memory. The method comprises: identifying, based on transaction data, payment transactions that are associated with predetermined airline carriers or flight routes; identifying, based on the identified payment transactions, one or more account holders associated with the identified payment transactions that exhibit predetermined payment transaction activity patterns corresponding to predetermined business-related spending; classifying the identified account holders into a plurality of segments based on transaction frequency with a target airline carrier; and generating, for a segment of the plurality of segments, data configured to facilitate engagement between the target airline carrier and account holders associated with the segment.

In one implementation, identifying the payment transactions that are associated with the predetermined airline carriers or flight routes comprises: extracting transaction features from the transaction data, the transaction features comprising characteristics indicative of airline carrier or flight route associations; and classifying, using a machine learning model, the payment transactions as being associated with the predetermined airline carriers or flight routes based on the extracted transaction features.

In one implementation, the method further comprises: training the machine learning model using a training data set comprising the transaction features and corresponding labels indicating associated airline carrier or flight route.

In one implementation, identifying the one or more account holders associated with the identified payment transactions that exhibit predetermined payment transaction activity patterns corresponding to business-related spending comprises: clustering, by transaction activity patterns, the one or more account holders associated with the identified payment transactions into a plurality of clusters; and identifying one or more of the plurality of clusters that exhibit the transaction activity patterns corresponding to business-related spending.

In one implementation, the method further comprises: extrapolating, for the segment, an estimated total payment transaction volume across a broader population of consumers sharing characteristics with account holders of the segment based on transaction data and market trend information associated with the account holders of the segment; and generating, based on the estimated total payment transaction volume, the data configured to facilitate engagement between the target airline carrier and account holders associated with the segment.

In one implementation, the method further comprises: analyzing transaction data associated with the segment to identify brands or product categories that are purchased by a same account holder within a predetermined temporal proximity to one another; and generating, based on the identified brands or product categories, the data configured to facilitate engagement between the target airline carrier and account holders associated with the segment, wherein the data configured to facilitate engagement is further configured to indicate the identified brands or product categories.

In one implementation, the method further comprises: analyzing transaction data associated with an account holder of the segment to identify recurring geographical locations corresponding to payment transactions made by the account holder; determining, based on the recurring geographical locations, a residence region for the account holder; and generating, based on the residence region, data configured to facilitate personalized engagement between the target airline carrier and the account holder.

In one implementation, a computer-implemented method is executed by at least one processor in communication with a memory. The method comprises: identifying, based on transaction data, payment transactions that are associated with a predetermined merchant, merchant category, or industry; identifying, based on the identified payment transactions, one or more account holders associated with the identified payment transactions that exhibit a predetermined payment transaction activity pattern; classifying the identified account holders into a plurality of segments based on transaction frequency with a target merchant; and generating, for a segment of the plurality of segments, data configured to facilitate engagement between the target merchant and account holders associated with the segment.

In one implementation, identifying payment transactions that are associated with predetermined associated with the predetermined merchant, merchant category, or industry comprises: extracting transaction features from the transaction data, the transaction features comprising characteristics indicative of associations with the predetermined merchant, merchant category, or industry; and classifying, using a machine learning model, the payment transactions as being associated with the predetermined merchant, merchant category, or industry based on the extracted transaction features.

In one implementation, the method further comprises: training the machine learning model using a training data set comprising the transaction features and corresponding labels indicating associated merchant, merchant category, or industry.

In one implementation, identifying the one or more account holders associated with the identified payment transactions that exhibit the predetermined payment transaction activity pattern comprises: clustering the one or more account holders associated with the identified payment transactions into a plurality of clusters; and identifying one or more of the plurality of clusters that exhibit the predetermined payment transaction activity pattern.

In one implementation, the method further comprises: extrapolating, for the segment, an estimated total payment transaction volume across a broader population of consumers sharing characteristics with account holders of the segment based on transaction data and market trend information associated with the account holders of the segment; and generating, based on the estimated total payment transaction volume, the data configured to facilitate engagement between the target merchant and account holders associated with the segment.

In one implementation, the method further comprises: analyzing transaction data associated with the segment to identify brands or product categories that are purchased by a same account holder within a predetermined temporal proximity to one another; and generating, based on the identified brands or product categories, the data configured to facilitate engagement between the target merchant and account holders associated with the segment, wherein the data configured to facilitate engagement is further configured to indicate the identified brands or product categories.

In one implementation, the method further comprises: analyzing transaction data associated with an account holder of the segment to identify recurring geographical locations corresponding to payment transactions made by the account holder; determining, based on the recurring geographical locations, a residence region for the account holder; and generating, based on the residence region, data configured to facilitate personalized engagement between the target merchant and the account holder.

In one implementation, at least one non-transitory computer-readable storage media has computer-executable instructions embodied thereon, wherein when executed by an intermediary transaction processing system including at least one processor in communication with a memory. The computer-executable instructions cause the at least one processor to: identify, based on transaction data, payment transactions that are associated with predetermined airline carriers or flight routes; identify, based on the identified payment transactions, one or more account holders associated with the identified payment transactions that exhibit predetermined payment transaction activity patterns corresponding to predetermined business-related spending; classify the identified account holders into a plurality of segments based on transaction frequency with a target airline carrier; and generate, for a segment of the plurality of segments, data configured to facilitate engagement between the target airline carrier and account holders associated with the segment.

In one implementation, the computer-executable instructions further cause the at least one processor to: extract transaction features from the transaction data, the transaction features comprising characteristics indicative of airline carrier or flight route associations; and classify, using a machine learning model, the payment transactions as being associated with the predetermined airline carriers or flight routes based on the extracted transaction features.

In one implementation, the computer-executable instructions further cause the at least one processor to: train the machine learning model using a training data set comprising the transaction features and corresponding labels indicating associated airline carrier or flight route.

In one implementation, the computer-executable instructions further cause the at least one processor to: cluster, by transaction activity patterns, the one or more account holders associated with the identified payment transactions into a plurality of clusters; and identify one or more of the plurality of clusters that exhibit the transaction activity patterns corresponding to business-related spending.

In one implementation, the computer-executable instructions further cause the at least one processor to: extrapolate, for the segment, an estimated total payment transaction volume across a broader population of consumers sharing characteristics with account holders of the segment based on transaction data and market trend information associated with the account holders of the segment; and generate, based on the estimated total payment transaction volume, the data configured to facilitate engagement between the target airline carrier and account holders associated with the segment.

In one implementation, the computer-executable instructions further cause the at least one processor to: analyze transaction data associated with the segment to identify brands or product categories that are purchased by a same account holder within a predetermined temporal proximity to one another; and generate, based on the identified brands or product categories, the data configured to facilitate engagement between the target airline carrier and account holders associated with the segment, wherein the data configured to facilitate engagement is further configured to indicate the identified brands or product categories.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a system in accordance with implementations of various techniques described herein.

FIGS. 2A-2I illustrate a sequencing diagram in accordance with implementations of various techniques described herein.

FIG. 3 illustrates a diagram of a method in accordance with implementations of various techniques described herein.

FIGS. 4-10 illustrate diagrams of a system and method in accordance with implementations of various techniques described herein.

FIG. 11 illustrates a diagram of a computing system in which one or more various technologies described herein may be incorporated and practiced.

### DETAILED DESCRIPTION

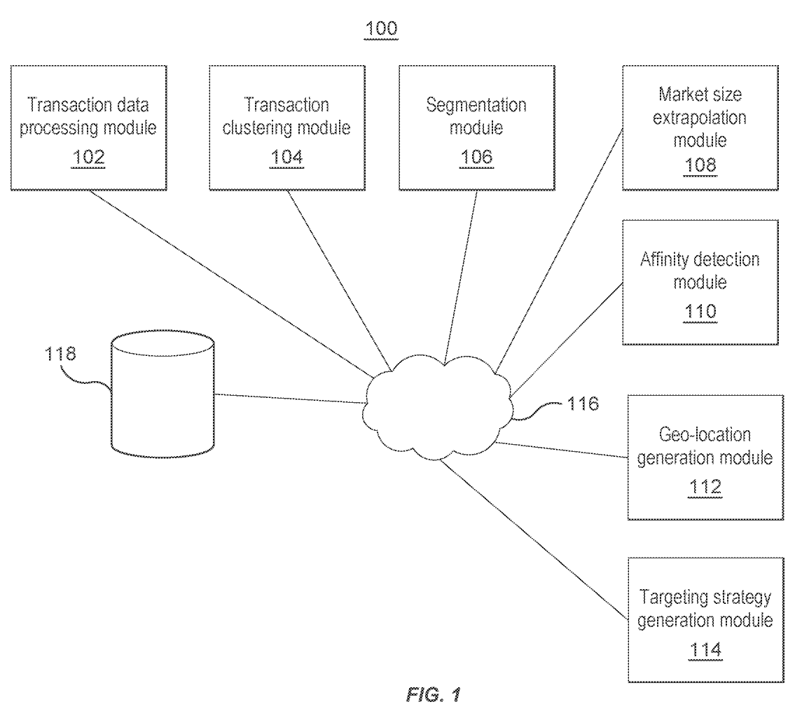

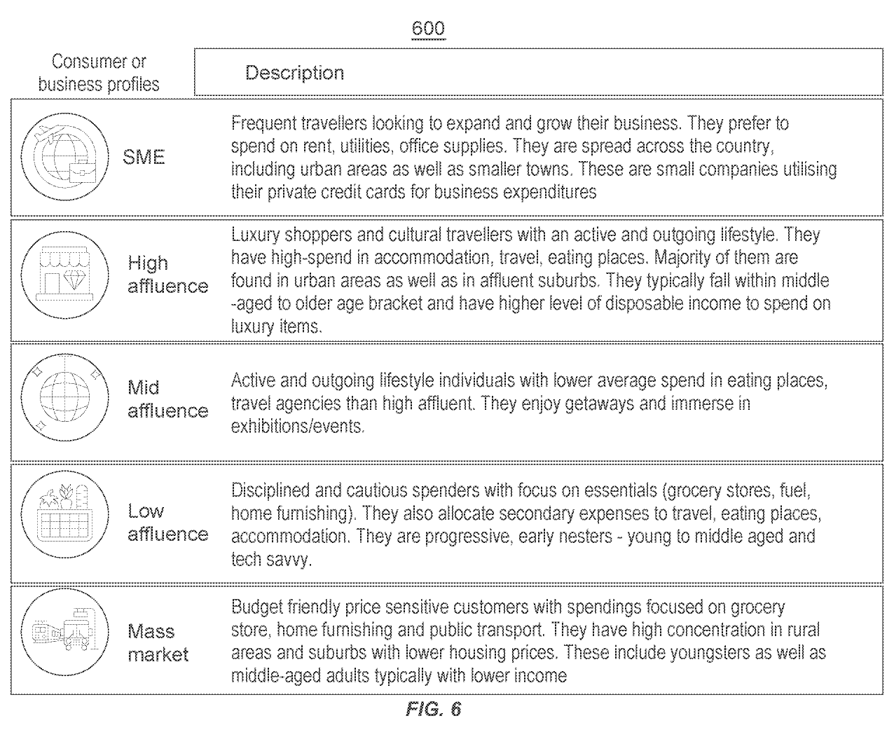

Various implementations directed to a system and method for enabling or promoting engagement between merchants and consumers based on payment transaction data will now be described in the following paragraphs with reference to FIGS. 1-10.

As is known in the art, a consumer may utilize a payment account to fund various types of financial transactions, including a payment transaction with a merchant. The consumer may be any entity known to those skilled in the art, including, but not limited to, the following: an individual person, a family, a commercial entity, a company, a corporation, a governmental entity, a non-profit organization, and/or the like. More specifically, the consumer may be a small or medium-sized enterprise (SME), which may refer to a business entity with limited revenue, employee count, or transaction volume, such as a sole proprietorship, partnership, or small incorporated company. The merchant may be an entity capable of providing one or more products for sale to the consumer. In particular, the merchant may be any entity known in the art, including, but not limited to, the following: an individual person, a family, a commercial entity, a company, a corporation, a governmental entity, a non-profit organization, and/or the like. The one or more products may include any good and/or service known to those skilled in the art. For example, the one or more products may include parts, material, merchandise, supplies, equipment, components, food, and/or the like.

The payment transaction may refer to a transaction by the consumer to purchase the one or more products from the merchant using funds from a payment account. As is known in the art, the payment transaction may be an in-person payment transaction and/or an online payment transaction between the consumer and the merchant. In addition, the payment account may be associated with the consumer (e.g., the consumer is the account holder) and may include any type of financial account known to those skilled in the art that can be used to fund the payment transaction. For example, the payment account may be a banking account, a checking account, a savings account, a credit card account, a debit card account, a prepaid card account, a virtual payment account, and/or the like.

In one scenario, the consumer may utilize a payment card in order to perform the payment transaction with the merchant. The payment card may be any type of card known in the art, including a physical card, a virtual card, or an electronic payment mechanism. Examples of the payment card may include, but are not limited to, the following: a debit card, a credit card, a prepaid card, a virtual payment card, virtual payment numbers, virtual card numbers, a foreign exchange card, a charge card, a stored-value card, an Automated Clearing House (ACH) transfer, other electronic transaction methods, and/or the like. As is known in the art, the payment card may be linked with the payment account of the consumer, such that the consumer can use the payment card to fund the payment transaction via the payment account.

However, while consumers engage in payment transactions with merchants to acquire products or services, merchants typically have limited visibility into the attributes or behaviors of those consumers beyond the basic transaction details. Payment transaction data may include various data fields associated with individual payment transactions, such as transaction amount, timestamp, merchant identifier, merchant category code (MCC), transaction geographical location, payment instrument identifier, and any other metadata relevant to the payment transaction. Payment transaction data is often recorded by payment networks, merchant acquirers, or issuing banks during the authorization, clearing, or settlement processes.

As such, merchants may lack access to, or the capacity to effectively utilize, payment transaction data to derive meaningful insights about consumer behavior. Even when payment transaction data is available, the data may be unstructured, fragmented, or limited to basic details, making it difficult to extract actionable insights. For example, an airline carrier may have visibility into ticket purchases but may be unable to determine which consumers are likely small and medium enterprises (SMEs), frequent travelers of competing airlines, or candidates of loyalty-based offerings.

This disclosure addresses a technical problem rooted in the structure, fragmentation, and underutilization of payment transaction data. The disclosed solution involves a system architecture that processes, analyzes, and transforms payment transaction data to generate actionable insights for merchants. In particular, the system architecture is configured to identify patterns indicative of consumer attributes (e.g., business-related spending, travel behavior, etc.), segment consumers into targeted categories, estimate market potential, and generate data configured to facilitate engagement between merchants and consumers. For illustrative purposes, certain implementations are described herein with reference to an airline industry use case; however, the disclosed implementations are broadly applicable to a wide range of merchants, industries, and consumer contexts.

### System

FIG. 1 illustrates a schematic diagram of a system 100 in accordance with implementations of various techniques described herein. The system 100 may include one or more networks 116, a transaction data processing module 102, a transaction clustering module 104, a segmentation module 106, a market size extrapolation module 108, an affinity detection module 110, a geo-location generation module 112, a targeted strategy generation module 114, and a data store 118.

The transaction data processing module 102, the transaction clustering module 104, the segmentation module 106, the market size extrapolation module 108, the affinity detection module, 110, the geo-location generation module, 112, the targeted strategy generation module 114, and the data store 118 may each be configured to communicate with one or more other elements of the system 100 via the one or more networks 116. The one or more networks 116 may include, but are not limited to, one or more of the following networks: a local area network (LAN), a wide area network (WAN) (e.g., the Internet), a mobile network, a virtual network, and/or any other public and/or private network known in the art capable of supporting communication among two or more of the elements of the system 100. In some scenarios, each of the modules of the system 100 may be deployed on a common server or processing environment. In such implementations, the modules of the system 100 may exchange data through shared memory, inter-process communication, or local file storage, rather than over the one or more networks 116. In some implementations, one or more modules of the system 100 may be configured to implement artificial intelligence or machine learning models (e.g., supervised learning models) to enable classification, pattern recognition, or predictive analysis based on transaction data, as described further below.

In some implementations, the one or more of the modules of the system 100 may be implemented on one or more computing devices, such as servers, virtual machines, or cloud-based platforms. Each computing device may be configured to perform the one or more functions described herein of the system 100. Additionally, in some implementations, the data store 118 may include one or more types of memory (e.g., solid-state drives, hard disk drives, or flash memory), and may be located locally within the system 100 or remotely accessible via the one or more networks 116, including cloud-based storage services.

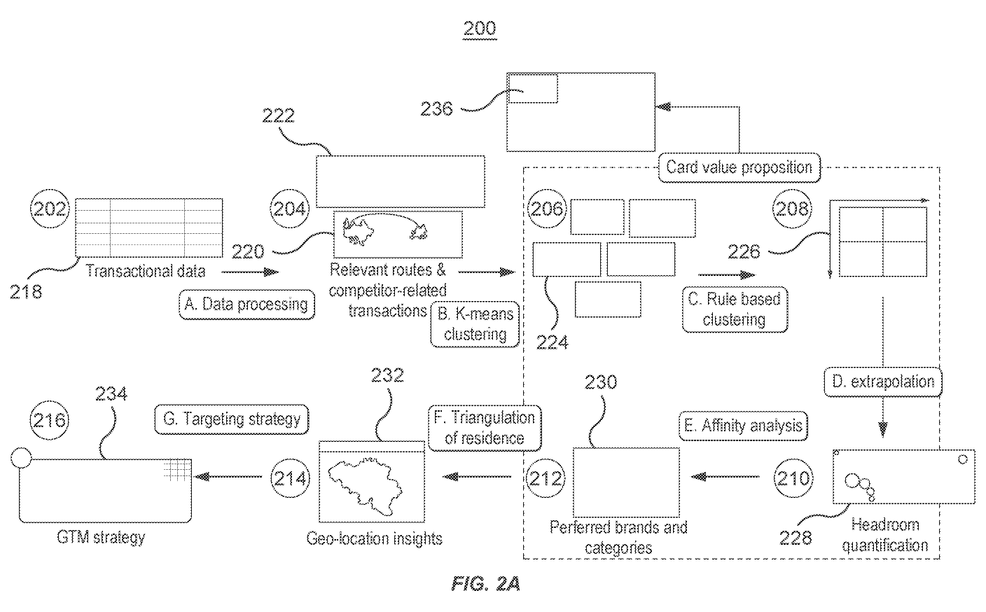

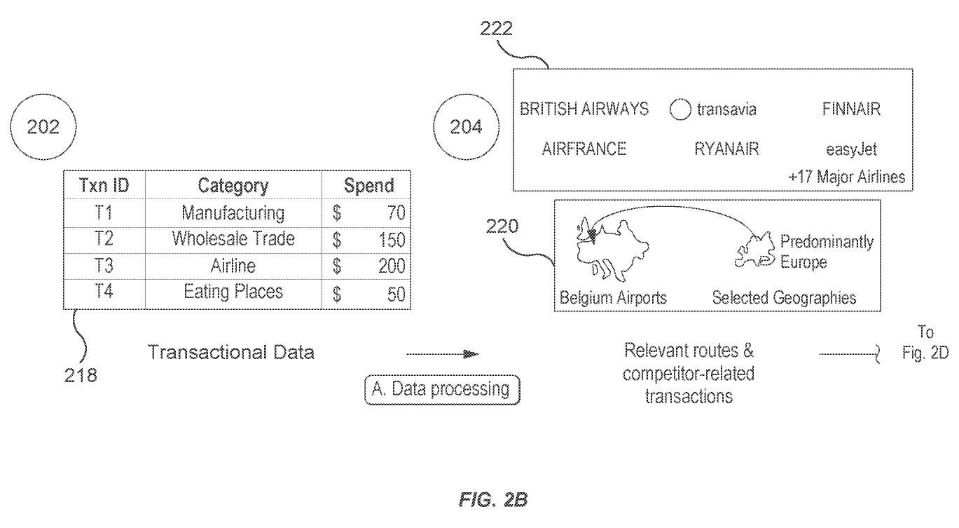

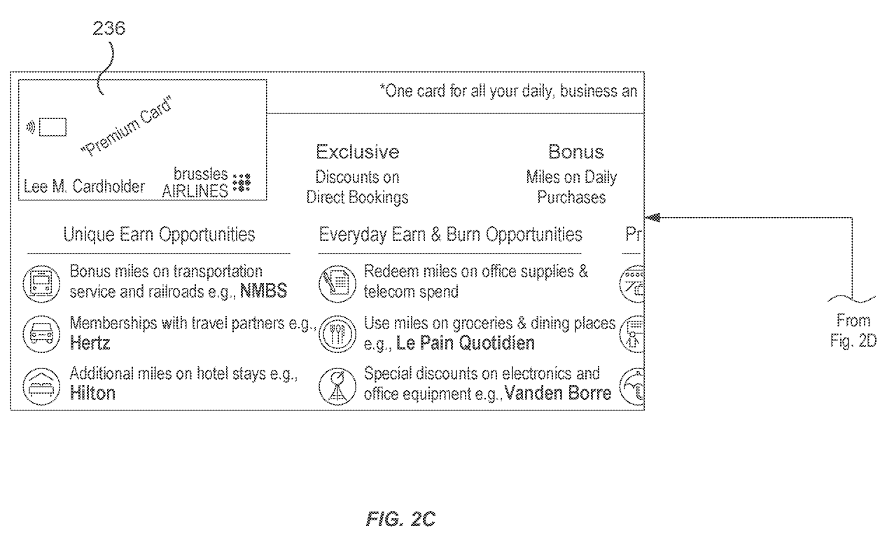

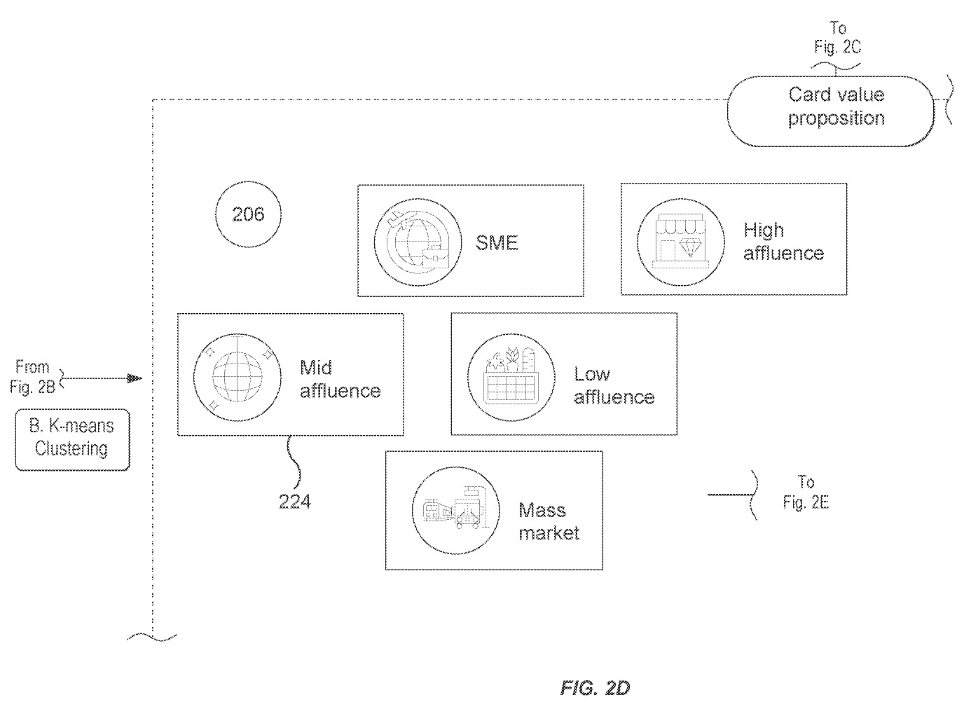

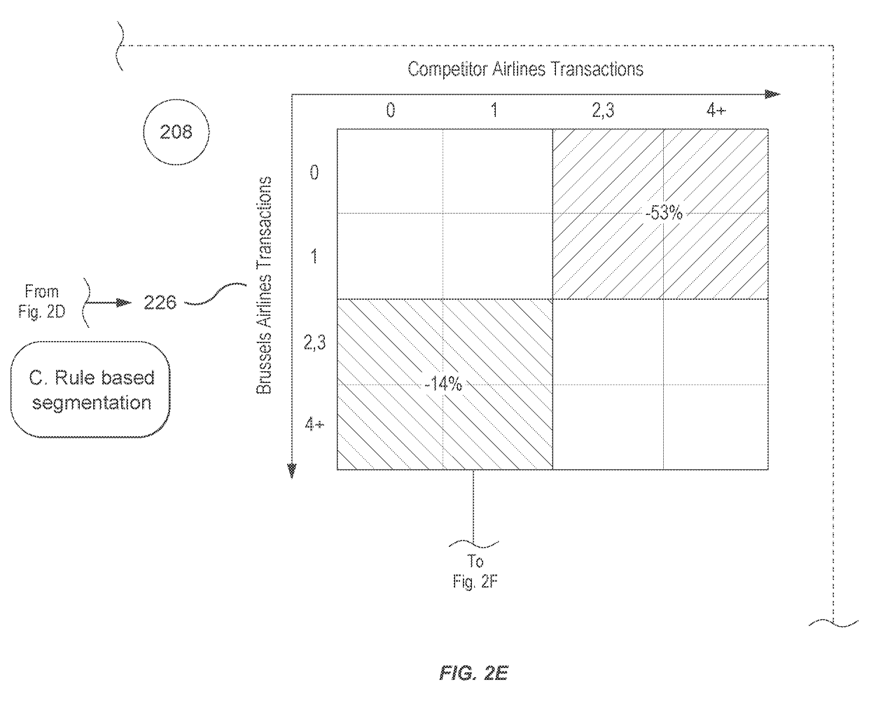

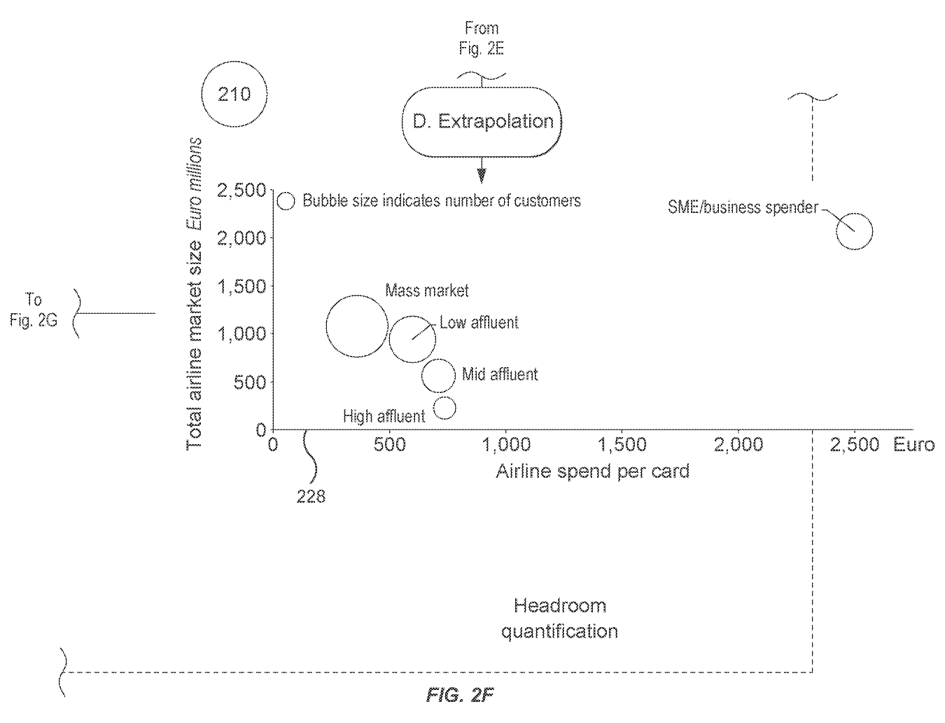

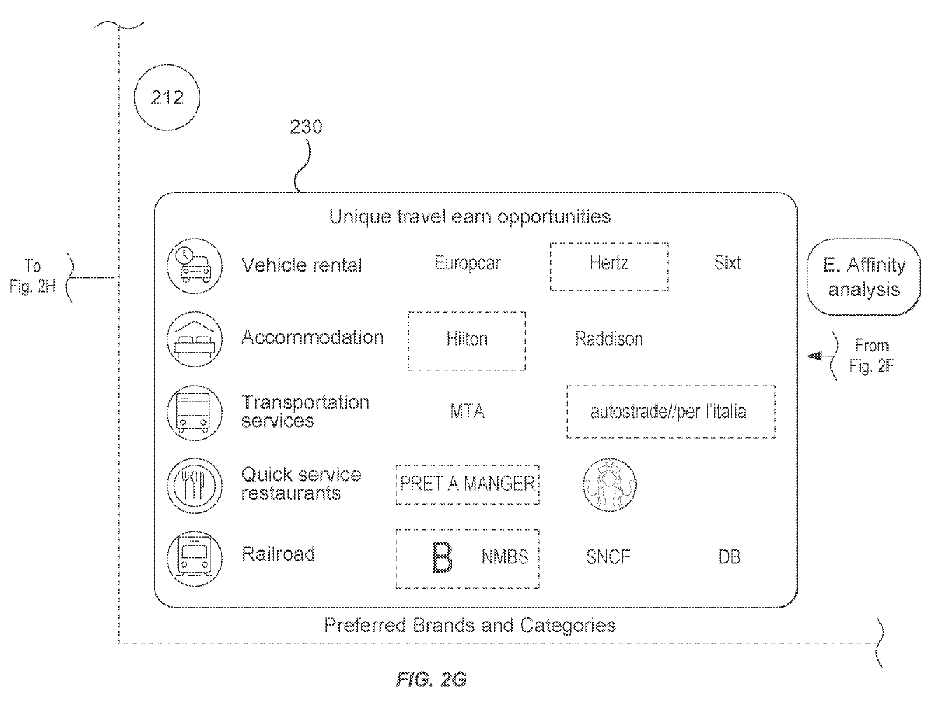

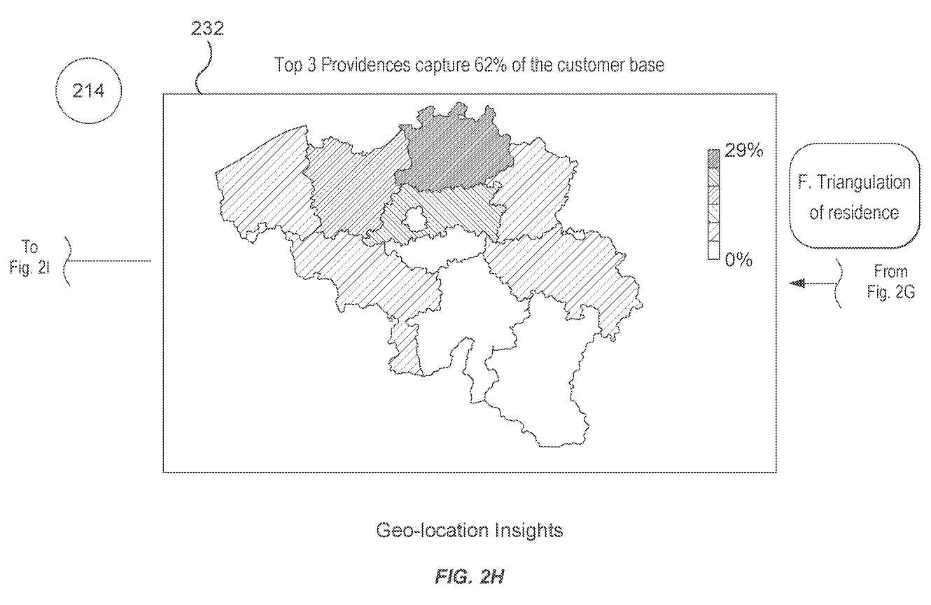

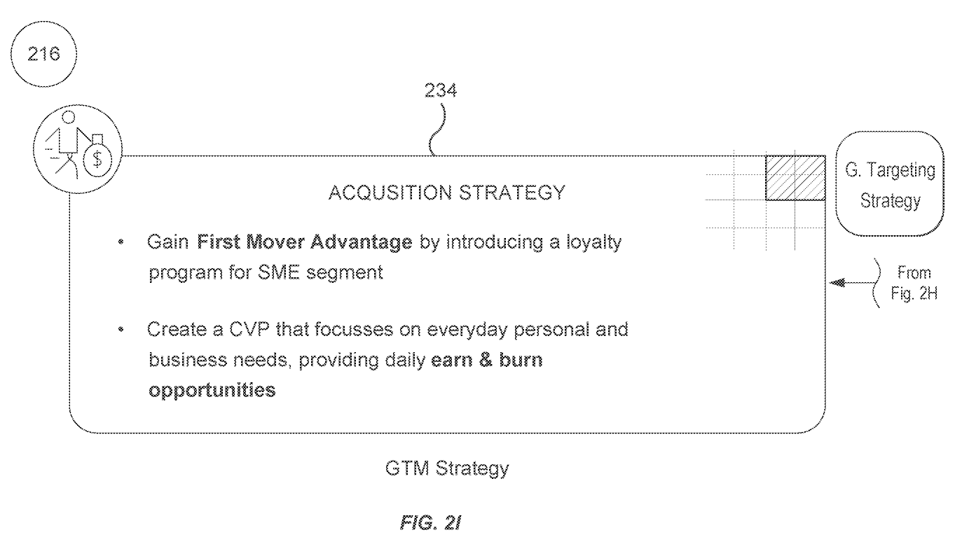

In FIG. 1, the transaction data processing module 102 may be configured to receive and process transaction data associated with a plurality of payment transactions. In some implementations, the transaction data processing module 102 may be configured to receive the transaction data from various external data sources, such as payment networks, merchant acquirers, card issuers, or internal data repositories. The transaction data processing module 102 may be further configured to identify, based on the transaction data, payment transactions that are associated with specific merchants, merchant categories, and/or industries. As used herein, a “merchant category” may refer to a classification that denotes the nature of a merchant’s business (e.g., travel, dining, office supplies, etc.), and an “industry” may refer to a broader commercial sector to which a merchant belongs. For example, in the context of the airline industry, the transaction data processing module 102 may infer from transaction data associated with one or more transactions that one or more payment transactions are associated with predetermined airline carriers or flight routes (as further illustrated in step 204 of FIGS. 2A and 2B). In some implementations, the merchants, merchant categories, and/or industries may be predetermined by a merchant, a network provider, or an operator of the system 100 based on historical data or marketing objectives.

Further, in some implementations, the transaction data processing module 102 may be configured to store the identified payment transactions data in the data store 118 for subsequent use by other modules of the system 100. Alternatively, or additionally, in some implementations, the transaction data processing module 102 may provide the identified transactions to one or more other modules of the system 100, such as the transaction clustering module 104 or the segmentation module 106.

Referring specifically now to the transaction clustering module 104, once the identified payment transactions data is provided by the transaction data processing module 102, the transaction clustering module 104 may be configured to identify one or more account holders that exhibit transaction activity patterns corresponding to predefined consumer or business profiles. As used herein, a “transaction activity pattern” may refer to a recognizable pattern of consumer behavior reflected in transaction data, such as frequency of purchases, types of merchants engaged, transaction amounts, or time-of-day activity, and “consumer or business profile” may refer to a category of account holders, such as SMEs, frequent travelers, or high-affluence consumers, that are defined based on transaction behavior characteristics.

In various implementations, to enable such identification, the transaction clustering module 104 may be further configured to group payment transactions into clusters representing similar patterns of consumer behavior. For example, the transaction clustering module 104 may apply a clustering technique (e.g., K-means clustering algorithm) to transaction data associated with payment transactions identified by the transaction data processing module 102 to identify groups of account holders with similar consumer behavior, such as airline spend concentration, merchant category mix, transaction recency, or payment method used. Once clustered, the transaction clustering module 104 may determine whether a cluster aligns with one or more predefined consumer or business profiles. For instance, a cluster characterized by frequent airline transactions, premium accommodation purchases, and high transaction amounts may be labeled as “frequent business travelers.” Conversely, a cluster with occasional flight bookings and low-cost accommodations may represent “budget leisure travelers.”

To help illustrate, in the context of the airline industry, for an airline carrier, the transaction clustering module 104 may identify account holders who, for example, regularly book weekday morning flights, use small-business or personal credit cards, and stay at business hotels, which may be transaction behavior characteristics consistent with SME travelers (as further illustrated in step 206 of FIGS. 2A and 2D). In some implementations, the consumer or business profiles or transaction activity patterns may be predetermined or predefined by a merchant, a network provider, or an operator of the system 100 based on historical data or marketing objectives.

Still yet, in some implementations, the transaction clustering module 104 may be further configured to store the identified account holder’s data in the data store 118 for subsequent use by other modules of the system 100. Alternatively, or additionally, in some implementations, the transaction data processing module 102 may provide the identified account holders data to one or more other modules of the system 100, such as the segmentation module 106 of the affinity detection module 110.

Referring specifically now to the segmentation module 106, the segmentation module 106 may be configured to classify the account holders into a plurality of segments based on interaction patterns with a target merchant or competitor merchants. In some implementations, the segmentation module 106 may be configured to classify account holders identified by the transaction clustering module 104 based on interaction patterns, such as transaction frequency or volume, with a target merchant or competitor merchants. These classifications may reflect engagement levels and may be used to define segments aligned with merchant-specific goals (e.g., acquisition, retention, growth).

For example, in the context of the airline industry, the segmentation module 106 may classify an account holder who frequently flies with the airline and infrequently with competitors into a “loyal” segment, whereas an account holder who frequently transacts with competitors but infrequently with the target airline may be assigned to a “competitive acquisition” segment (as further illustrated in step 208 of FIGS. 2A and 2E). These segments may support personalized targeting, loyalty campaigns, or re-engagement strategies. In some implementations, the segmentation data generated by the segmentation module 106 may be provided to other modules of the system 100, such as the market size extrapolation module 108, the affinity detection module 110, and the target strategy generation module 114, to configure downstream outputs, or stored in the data store 118 for subsequent use.

Referring specifically now to the market size extrapolation module 108, the market size extrapolation module 108 may be configured to estimate an overall market size or total spend associated with a given segment of account holders based on transaction data and market trend information. As used herein, “market size” or “total spend” may refer to an estimate of the overall monetary value of transactions conducted by a target population within a particular category, industry, or segment. This may include actual observed transaction data as well as projected transaction activity of consumers who are not directly captured in the observed data, accounting for variables such as payment network share, card penetration, or segment-specific usage trends.

In some implementations, the market size extrapolation module 108 may utilize data provided by other modules of the system 100 (e.g., the segmentation module 106 or the transaction data processing module 102) to identify the scope and characteristics of a segment and apply scaling factors to account for limitations in the available transaction data. These factors may include payment network share, card penetration rates, regional representation, or known coverage gaps. For example, in the context of the airline industry, the market size extrapolation module 108 may receive data indicating that a segment of account holders frequently transacts with a particular airline (as further illustrated in step 210 of FIGS. 2A and 2F). If these transactions are drawn from only a subset of total payment methods or networks (e.g., Mastercard® transactions), the module may adjust the data to estimate the total market size of such consumers, including those transacting via other networks or instruments. In some implementations, the market size extrapolation module 108 may extrapolate, for the segment, an estimated total payment transaction volume across a broader population of consumers sharing characteristics with account holders of the segment based on transaction data and market trend information associated with the account holders of the segment.

Still yet, in some implementations, the market size extrapolation module 108 may be further configured to store the extrapolated market size data in the data store 118 for subsequent use by other modules of the system 100. Alternatively, or additionally, in some implementations, the market size extrapolation module 108 may provide the extrapolated market size data to one or more other modules of the system 100, such as the target strategy generation module 114.

Referring specifically now to the affinity detection module 110, the affinity detection module 110 may be configured to analyze transaction data associated with a segment to identify preferred brands or product categories of the account holders of the segment. More specifically, in some implementations, the affinity detection module 110 may identify frequent co-purchase patterns, where account holders of the segment tend to purchase specific categories or brands together during a given transaction period.

To illustrate, in the context of the airline industry, the affinity detection module 110 may determine that account holders classified in a “frequent traveler” segment often purchase airline tickets alongside hotel bookings or car rentals from specific brands (e.g., Hilton, Hertz) (as further illustrated in step 212 of FIGS. 2A and 2G). This insight may indicate a preference for bundled travel services, which could be used to guide loyalty offers or co-branded promotions.

In some implementations, the data generated by the affinity detection module 110 may be provided to other modules of the system 100, such as the targeted strategy generation module 114, to inform campaign creation, or stored in the data store 118 for subsequent use by the modules of the system 100.

Referring specifically now to the geo-location generation module 112, the geo-location generation module 112 may be configured to identify a residence region for an account holder of a segment based on recurring transaction activity. As used herein, a residence region may refer to a geographic area associated with an account holder’s likely home location, such as a zip code, neighborhood, city sector, or other defined area inferred from location-specific transaction data. In some implementations, the geo-location generation module 112 may analyze transaction data associated with an account holder to identify recurring geographical locations indicative of home-use merchant categories or everyday spend categories (e.g., grocery stores, pharmacies, or fuel stations). For example, the geo-location generation module 112 may then determine, based on the frequency, timing, and volume of transactions within geographic areas, a residence region (e.g., a postal zip code) most likely corresponding to the account holder’s home location (as further illustrated in step 214 of FIGS. 2A and 2H).

In some implementations, the residence region data may be provided to other modules in the system 100, such as the targeted strategy generation module 114, to generate personalized campaign strategies, or to the segmentation module 106 to support geo-specific customer segmentation. In some implementations, the residence region data may also be stored in the data store 118 for later retrieval and/or use by modules of the system 100.

Referring specifically now to the targeted strategy generation module 114, the targeted strategy generation module 114 may be configured to generate data configured to facilitate engagement between a target merchant and account holders associated. In some implementations, the data generated may incorporate insights derived from the one or more modules of the system 100, such as segmentation classifications, market size extrapolations, brand affinities, or residence regions, so as to enable tailored, contextually relevant engagement strategies for a merchant.

For example , in the context of the airline industry, the targeted strategy generation module 114 may generate data configured to facilitate engagement between an airline carrier and an account holder of a segment of “frequent travelers” with high brand affinity for bundled travel services (e.g., airlines, hotel chains, and car rental providers) and a residence region located near a key airport hub (as further illustrated in step 216 of FIGS. 2A and 2I). In particular, the targeted strategy generation module 114 may generate strategy data recommending loyalty rewards, co-branded service offers, or location-specific promotions targeting the account holder or segment. This strategy data may then be used to deliver personalized advertisements, promotional messages, or offer recommendations via one or more communication channels, including mobile, web, or email platforms. In some implementations, the strategy data may be stored in the data store 118 for scheduled or repeated activation or may be transmitted directly to external engagement systems for execution.

FIGS. 2A-2I illustrates an example implementation of the system 100 in the context of the airline industry, particularly for identifying and targeting SME travelers. In particular, FIG. 2A provides an overview of the example implementation of the system 100, and FIGS. 2B–2I illustrate expanded and more detailed views of the example implementation, including specific processing steps and components corresponding to those introduced in FIG. 2A. This real-world use case demonstrates how payment transaction data can be transformed into actionable marketing insights by applying the various modules of the system 100.

In step 202, with reference to FIGS. 2A and 2B, the transaction data processing module 102 may receive payment transaction data from payment networks, card issuers, or merchant acquirers. The payment transaction data may include transaction identifiers, merchant category codes (MCC), spend amounts, and other associated metadata. For instance, in a payment transaction table 218, transaction T3 reflects airline-related spending and has a transaction amount of $200.

Further, in step 204, with reference to FIGS. 2A and 2B, the transaction data processing module 102 may process payment transaction data to identify airline-related transactions associated with specific airline carriers and flight routes. For instance, transaction T3 in payment transaction table 218 may be associated with a spend category labeled “Airline,” and may be linked to a transaction involving Brussels Airlines®. Based on transaction data associated with a payment transaction, such as merchant identifiers, MCC codes, or issuer-supplied airline mappings, the transaction data processing module 102 may associate the payment transaction with a relevant airline route or airline carrier.

As further depicted in step 204, the transaction data processing module 102 may identify payment transactions involving specific airline routes and airline carriers who are competitors to a target airline carrier. For example, the transaction data processing module 102 may identify airline payment transactions associated with a selected region 220, including Belgium airports and European travel corridors, and competitor airline carriers 222, including British Airways®, Transavia®, Finnair®, Air France®, easyJet® and Ryanair®, which are competitors to Brussels Airlines®. This may enable the system 100 to isolate competitor-related spend behaviors, filter transactions by airline carrier or route, and generate insights for downstream analysis by other modules of the system 100.

In step 206, with reference to FIGS. 2A and 2D, the transaction clustering module 104 may apply a clustering technique (e.g., K-means clustering algorithm) to the transaction data associated with the selected region 220 and the competitor airline carriers 222 to classify account holders into one or more clusters 224 that reflect similar patterns of consumer behavior. Clustering may be based on features such as airline spend concentration, transaction frequency, merchant category mix, or other payment transaction behavior characteristics derived from the transaction data.

Once the one or more clusters 224 are formed, the transaction clustering module 104 may compare the one or more clusters 224 to predefined consumer or business profiles to determine alignment. For example, a cluster may exhibit characteristics similar to one or more of the following consumer or business profiles:

A “SME traveler” profile, characterized by frequent airline transactions and high spend concentrations across business-related categories such as office supplies, utilities, and accommodations. These account holders may use private or small-business credit cards for travel.

A “high-affluence” profile, which may include account holders with luxury preferences, who demonstrate high total card spend and frequently book premium travel and accommodations.

A “mid-affluence” profile, which may be associated with account holders who demonstrate moderate total card spend and consistent travel purchases, often linked to leisure or events attendance.

A “low-affluence” profile, which may include account holders who have limited travel engagement and lower overall card spend, often linked to essential purchases and occasional airline transactions.

A “mass market” profile, which may reflect price-sensitive consumers with concentrated spend in grocery and public transport categories, and minimal airline engagement.

These insights may support subsequent segmentation and personalization of engagement strategies by downstream modules in the system 100.

In step 208, with reference to FIGS. 2A and 2E, the segmentation module 106 may apply a rule-based segmentation framework (e.g., 9-box matrix segmentation) to classify account holders within the one or more clusters 224 based on their transaction behavior with the target airline carrier, Brussels Airlines®, relative to the competitor airline carriers 222. For example, as illustrated by a segmentation matrix 226, the segmentation module 106 may generate a matrix with dimensions representing transaction frequency with Brussels Airlines® and the competitor airlines carriers 222. Each cell in the segmentation matrix 226 may correspond to a distinct behavioral segment. For instance, account holders in the upper-right quadrant (e.g., high frequency with both the target and competitor airline carriers) may be categorized as loyal, high-value travelers, indicating potential for strategic retention and upsell efforts. In contrast, account holders in the lower-left quadrant (e.g., low transaction frequency across all airline carriers) may be deprioritized and assigned a lower engagement tier. This segmentation approach may enable tailored strategies for different subgroups within each cluster based on loyalty dynamics, competitive switching behavior (i.e., likelihood of switching to a competitor from the target airline), or growth potential.

In step 210, with reference to FIGS. 2A and 2F, the market size extrapolation module 108 may estimate the headroom or market potential associated with a segment (as identified by the segmentation module 106) or a cluster (as generated by the transaction clustering module 104) by projecting observed spend or behavioral data from a representative sample to the broader population. This may involve applying scaling factors based on known payment network limitations, such as payment network share, card penetration rates, or regional coverage gaps.

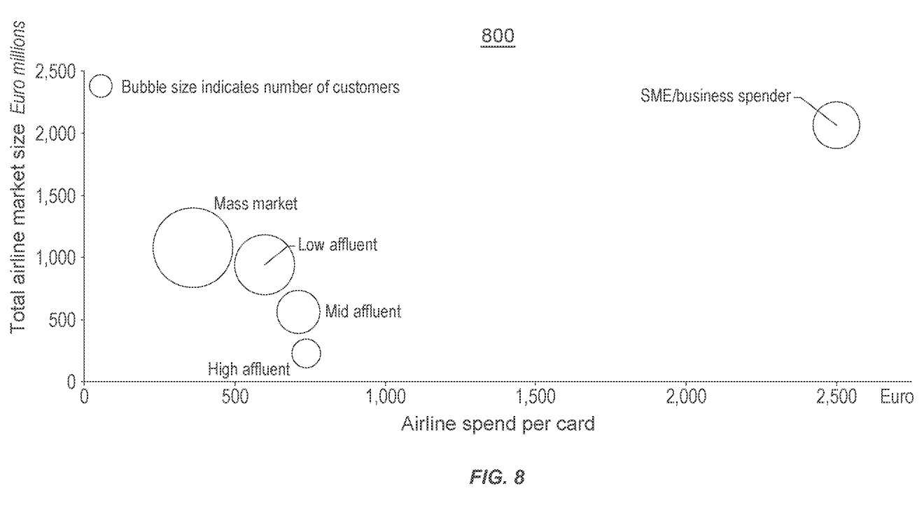

To illustrate, a plot 228 visualizes extrapolated data generated by the market size extrapolation module 108. In particular, the market size extrapolation module 108 may be configured to estimate metrics such as total airline market size (represented on the y-axis) and average airline spend per card (represented on the x-axis) for various predefined consumer or business profiles. These profiles may include categories such as SME, mass market, low-affluence, mid-affluence, and high-affluence. The size of each bubble in the plot 228 reflects the estimated number of consumers in each profile, extrapolated beyond the observed transaction data. This may enable identification of market “headroom” by highlighting which profiles offer high spend and large potential reach. For example, an SME profile in the upper-right quadrant of the plot may represent a high-value opportunity for premium offers, while other profiles with lower values may be deprioritized for engagement. The plot 228 is further illustrated more clearly in FIG. 8.

In step 212, with reference to FIGS. 2A and 2G, the affinity detection module 110 may identify preferred brands and product categories associated with a segment or cluster, such as travel chains, car rentals, or food establishments, by analyzing co-purchase behavior. “Co-purchased,” as used herein, refers to brands or product categories that are purchased by the same account holder within a predetermined temporal proximity, such as during the same transaction, within the same billing cycle, or within a predefined time window (e.g., forty-eight hours, seven days, etc.), such that the purchases are likely to reflect a behavioral association or consumer preference. For instance, if a traveler often books a hotel and a car rental on the same trip or purchases airline tickets and airport dining in close succession, these pairings may indicate an affinity.

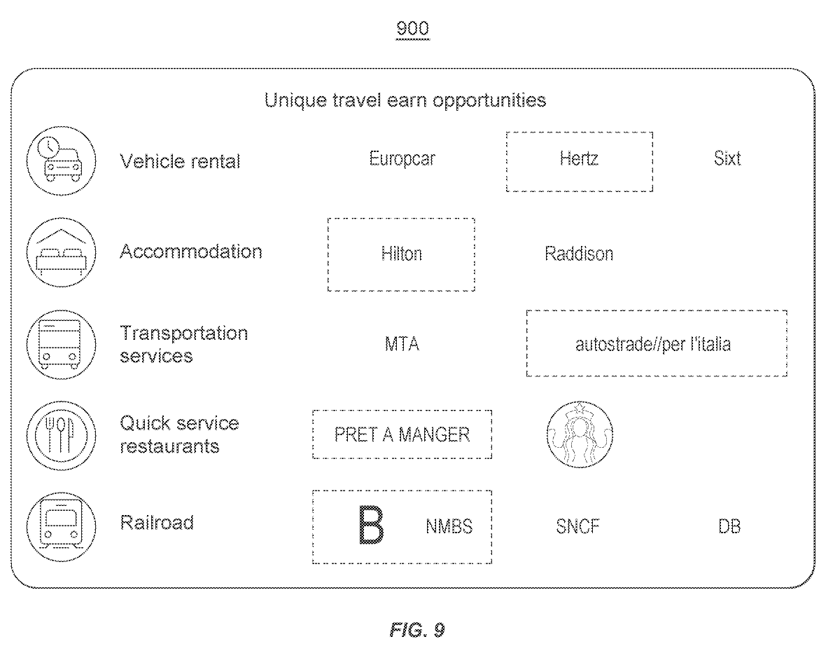

For an illustrative example 230, brands are grouped under key travel-related categories, such as vehicle rental (e.g., Europcar®, Hertz®, Sixt®), accommodation (e.g., Hilton®, Radisson®), transportation services (e.g., Metropolitan Transportation Authority (MTA), Autostrade per I’Italia®), quick service restaurants (e.g., Starbucks®, Pret A Manger®), and railroad providers (e.g., Société nationale des chemins de fer français (SNCF®), Deutsche Bahn (DB®), National Railway Company of Belgium NMBS/SNCB®). In the example 230, the highlighted brands, Hertz®, Hilton®, Pret A Manger®, and NMBS®, may reflect co-purchase behavior determined within a segment or cluster of account holders, suggesting that account holders of the segment or cluster frequently transact with these specific brand combinations. For instance, account holders of the SME traveler segment may often book a Hilton® stay along with a Hertz® rental and train service via DB®. The illustrative example 230 is further illustrated more clearly in FIG. 9.

In step 214, with reference to FIGS. 2A and 2H, the geo-location generation module 112 may determine a likely residence region for a given account holder based on analysis of recurring, location-specific transaction activity. In the context of Brussels Airlines, this may include detecting weekday transactions near Brussels Airport, repeated purchases at local supermarkets, fuel stations, or pharmacies within a specific area. These behaviors may indicate that the account holder resides in or frequently commutes through that geographic region.

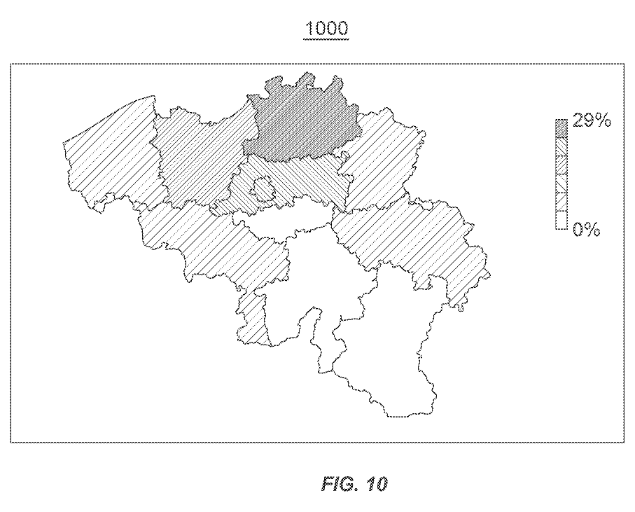

In some implementations, as illustrated in an example 232, the geo-location generation module 112 may rank potential residence regions by likelihood, enabling Brussels Airlines® to deliver localized marketing offers to the account holder. For example, an account holder inferred to reside near Antwerp may receive promotional offers for flights departing from Brussels Airport with added incentives like train transfer discounts or local check-in perks. Such targeting may enhance campaign relevance by aligning offers with the account holder’s travel patterns and geographic proximity. The illustrative example 232 is further illustrated more clearly in FIG. 10.

In step 216, with reference to FIGS. 2A and 2I, the targeted strategy generation module 114 may generate engagement data configured to support personalized marketing and acquisition strategies between Brussels Airlines® and account holders. The targeted strategy generation module 114 may synthesize insights produced by upstream modules of the system 100, such as segmentation insights from the segmentation module 106, market extrapolation data from the market size extrapolation module 108, brand preferences from the affinity detection module 110, and geo-location analysis from the geo-location generation module 112, to tailor offers to specific profiles or behavioral patterns of consumers.

For example, as shown in an illustrative example 234, the targeted strategy generation module 114 may generate a go-to-market (GTM) strategy focused on acquiring SME travelers by introducing a dedicated loyalty program aligned with everyday personal and business needs. A targeted strategy may include daily earn-and-burn opportunities, such as bonus miles on weekday business flights, bundled offers with preferred hotel and car rental brands (e.g., Hilton® and Hertz®), and perks localized to the account holder’s likely residence region (e.g., Antwerp), such as transit discounts to Brussels Airport. The targeted strategy generation module 114 may thus facilitate deployment of first-mover marketing campaigns based on actionable insights derived from upstream modules of the system 100, enabling Brussels Airlines to tailor outreach to specific segments and clusters.

In some implementations, the targeted strategy generation module 114 may generate engagement data that comprises a card value proposition, as depicted in an illustrative example 236 in FIG. 2C, which highlights everyday “earn and burn” opportunities through co-branded credit cards or membership programs. For instance, an account holder inferred to reside near Antwerp and aligned with the SME profile may receive a targeted offer for a Brussels Airlines® -branded credit card featuring bonus miles for weekday flights, hotel stays, and transit to Brussels Airport. These targeted strategies may enhance acquisition and loyalty by aligning offers to account holders’ specific travel behavior, preferences, and likely location.

The one or more modules mentioned above may be implemented using one or more software-based systems, one or more hardware-based systems, or combinations thereof. Further, the one or more modules mentioned above may be configured to perform the one or more operations described herein using one or more applications downloaded to, installed in, and/or active in these one or more computing systems. In addition, the one or more modules mentioned above may communicate with one another using any technique known to those skilled in the art. For example, though not shown in FIGS. 1 and 2A-2I, these one or more modules may communicate with one another using one or more application programming interfaces (APIs) associated with the one or more applications. In another example, the one or more applications used by at least some of the modules may include a web browser, such that the web browser may be used to communicate with other modules of the system 100 via the one or more networks 116. Moreover, although the system 100 is presented in one arrangement, other implementations may include one or more elements of the system 100 in different arrangements and/or with additional elements.

### Operation

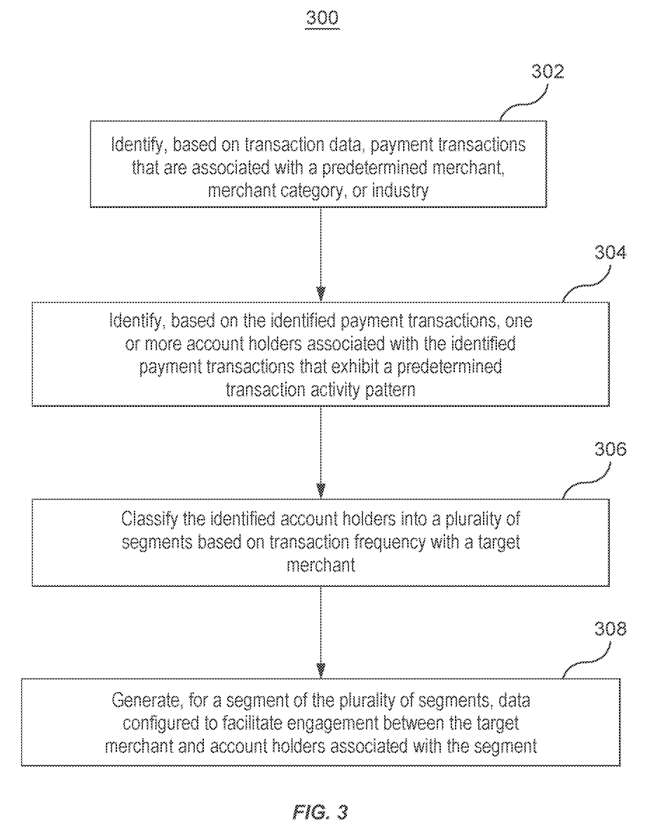

The process described with reference to FIGS. 1 and 2A-2I will now be described in more detail with reference to FIGS. 3-10.

FIG. 3 illustrates a diagram of a method 300 for enabling or promoting engagement between merchants and consumers based on payment transaction data. At step 302 of the method 300, payment transactions that are associated with predetermined merchants, merchant categories, or industries are identified based on transaction data. For example, the transaction data processing module 102 may analyze incoming or historical transaction data to detect payment transactions that match predefined classification criteria, such as airline purchases, hotel bookings, or transportation-related spending.

At step 304 of the method 300, one or more account holders associated with the identified payment transactions, who exhibit predetermined transaction activity patterns corresponding to predefined consumer or business profiles, are identified based on the identified transactions. For example, the transaction clustering module 104 may use unsupervised learning techniques (e.g., K-means clustering) to group account holders based on attributes such as transaction frequency, merchant type, and payment behavior. To illustrate, a cluster characterized by weekday morning flights and use of business credit cards may correspond to SME travelers.

At step 306 of the method 300, the identified account holders are classified into a plurality of segments based on transaction frequency with a target merchant. For example, the segmentation module 106 may classify each identified account holder into a plurality of segments based on transaction frequency with a target merchant. This may involve applying rule-based logic or a matrix-based framework (e.g., a 3×3 or 9-box matrix) that evaluates both the account holder’s transaction frequency with the target merchant and with competitor merchants. The result may be a segmentation of the merchant’s customer base, such as “high-frequency target customers,” “low-frequency competitor-loyal customers,” or “opportunity segment.”

At step 308 of the method 300, data configured to facilitate engagement between the target merchant and account holders associated with a segment of the plurality of segments is generated. For example, the targeted strategy generation module 114 may generate data configured to facilitate engagement between the target airline merchant and account holders within that segment. In particular, this may include recommending loyalty incentives, promotional offers, or personalized communications.

Each of the following subsections describes a respective module of the system 100 in greater detail, including how the module may be implemented, how it may function within the system 100, and how it may contribute to enabling identification and targeted engagement. Note that the modules of the system 100 may be implemented in various ways to perform their functions.

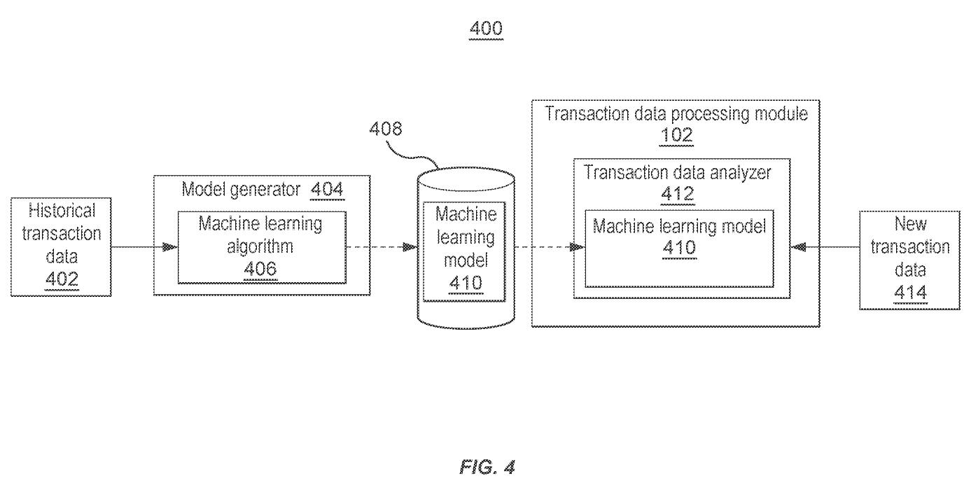

Referring specifically now to the transaction data processing module 102, FIG. 4 illustrates an example block diagram of a system 400 that may be used to generate a machine learning model and apply the machine learning model to identify payment transactions associated with specific merchants, merchant categories, and/or industries based on transaction data. As shown in FIG. 4, the system 400 includes a model generator 404 and the transaction data processing module 102. As further shown in FIG. 4, the transaction data processing module 102 includes a transaction data analyzer 412.

In some implementations, the model generator 404 is configured to generate a machine learning model 410, which may be used to identify payment transactions that are associated with specific merchants, merchant categories, and/or industries and store the machine learning model 410 in a data store 408. Data store 408 may include one or more of any type of suitable storage medium, such as a hard disk, solid-state drive, magnetic disk, optical disk, read-only memory (ROM), or random-access memory (RAM).

In some implementations, the machine learning model 410 may be trained on historical transaction data. For example, as depicted in FIG. 4, the model generator 404 may provide historical transaction data 402 to the machine learning algorithm 406. The model generator 404 may also include a machine learning application (e.g., TensorFlow™) that implements the machine learning algorithm 406 to generate the machine learning model 410. When the machine learning algorithm 406 is implemented, the machine learning algorithm 406 may find patterns in the historical transaction data 402 and output a model that captures these patterns to enable identification of payment transactions that are associated with specific merchants, merchant categories, and/or industries based on transaction data.

The machine learning model 410 may be generated using any suitable techniques, including supervised machine learning model generation algorithms such as support vector machine, linear regression, logistic regression, naïve Bayes, linear discriminant analysis, decision trees, k-nearest neighbor algorithm, neural networks, recurrent neural network, etc. Also, note that the machine learning model 410 may be generated in various forms. For instance, if the machine learning model 410 is generated using a support vector machine, the form of the model may vary depending on the chosen kernel function. A linear kernel may be used when the transaction features are linearly separable, while a non-linear kernel, such as a radial basis function (RBF), may be used to capture more complex, non-linear relationships between transaction data and merchant categories.

In some implementations, the model training process may begin with data preprocessing, such as encoding categorical variables (e.g., payment methods, airport codes, airline names) into machine-readable form. Relevant features that most strongly influence classification outcomes, such as flight route, transaction amount, or time of purchase, may be selected. The processed data may be split into a training set and a test set, and the machine learning model 410 is trained on the labeled training set using the selected features. In some implementations, the performance of the machine learning model 410 may be evaluated using accuracy, precision, recall, and F1 score, and further improved via cross-validation and hyperparameter tuning. Once validated, the machine learning model 410 may be used to label or classify new transaction data 414.

As described, the transaction data processing module 102 may be configured to analyze payment transaction data to classify transactions based on patterns associated with specific merchants, merchant categories, or industries. In particular, as illustrated in FIG. 4, the machine learning model 410 may be deployed within the transaction data analyzer 412 and the transaction data analyzer 412 may use the machine learning model 410 to infer characteristics for the new transaction data 414.

In the context of the airline industry, for example, the transaction data processing module 102 may be used to classify payment transactions related to airline purchases. For instance, transactions may be labeled to identify the specific airline carrier (e.g., Brussels Airlines or a competitor airline carrier), the flight route (e.g., Brussels to Madrid), and the origin and destination airports. The machine learning model 410 may be trained on a labeled dataset of known airline transactions, enabling it to recognize carrier patterns in the new transaction data 414. Once deployed, the machine learning model 410 may identify whether a transaction corresponds to a Brussels Airlines flight or a competing airline carrier, based on extracted features from transaction data, such as the airline name, associated airport codes, and transaction metadata.

Referring specifically now to the transaction clustering module 104, as described, the transaction clustering module 104 may be configured to segment account holders based on similarities in their payment transaction behavior. In some implementation, the transaction clustering module 104 may apply unsupervised machine learning techniques to group account holders into distinct behavioral clusters.

In some implementations, K-means clustering may be employed to identify behavioral clusters by measuring Euclidean distances between data points (i.e., customer transaction vectors) and the centroids of each cluster. Each cluster centroid represents a prototypical behavior pattern derived from transaction attributes. The number of clusters (K) may be predetermined based on domain knowledge (e.g., six distinct groups such as SME, high-affluence, mid-affluence, low-affluence, mass market, and another distinct segment) or estimated dynamically using methods such as the elbow method.

To perform clustering, the transaction clustering module 104 may first collect relevant features from historical transaction data associated with payment transactions. These features may include, for example: transaction frequency, average transaction amount, total transaction volume, merchant category distribution (e.g., luxury hotels, budget accommodations, business services, airline spend, grocery, family spend, etc.), payment method used (credit, debit, prepaid), transaction recency (active vs. dormant), and travel-related transaction count (e.g., airlines, hotels, car rentals).

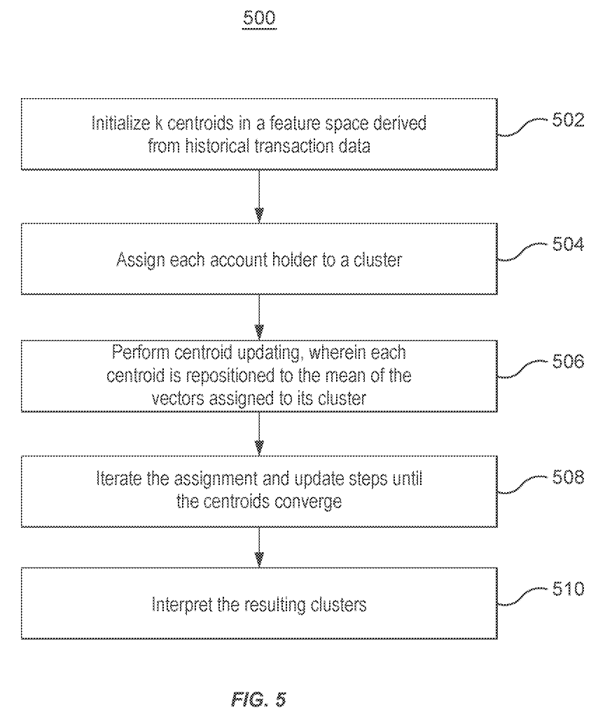

FIG. 5 illustrates an example flow diagram of a method that may be implemented by the transaction clustering module 104 to group account holders into behavior-based clusters using the K-means clustering algorithm. At step 502, the transaction clustering module 104 may initialize K centroids in a feature space derived from historical transaction data. Each centroid may represent an initial hypothesized behavioral cluster. At step 504, the transaction clustering module 104 may assign each account holder to a cluster by computing the Euclidean distance between the account holder’s transaction vector and each centroid, assigning the vector to the closest centroid. At step 506, the transaction clustering module 104 may perform centroid updating, wherein each centroid is repositioned to the mean of the vectors assigned to its cluster. At step 508, the transaction clustering module 104 may iterate the assignment and update steps until the centroids converge (i.e., until the centroid positions stabilize across iterations). At step 510, the transaction clustering module 104 may interpret the resulting clusters by analyzing aggregate transaction characteristics, such as spend levels, frequency, and merchant category distribution to assign behavioral labels.

In some implementations, the transaction clustering module 104 may compare one or more generated clusters to predefined consumer or business profiles to assess alignment. The consumer or business profiles may be defined in advance based on historical transaction patterns, behavioral transaction patterns, behavioral indicators, and domain-specific knowledge and serve as reference archetypes for interpreting behavioral segmentation outcomes.

°SME Traveler: This profile represents frequent travelers seeking to grow their business. These individuals or small business owners often show high transaction frequency and spend in business-related categories such as office supplies, fuel, utilities, and accommodations. They may use small business or commercial credit cards and are distributed across both urban and rural areas.

°High Affluence: Account holders in this category are luxury shoppers and cultural travelers with high card spend, particularly in premium categories like upscale accommodations, travel, and dining. These individuals typically reside in affluent suburbs and fall within the middle-aged to older adult demographic with high disposable income.

°Mid Affluence: This group comprises active and outgoing individuals who engage in consistent travel and leisure-related purchases but at moderate spend levels. Their transaction patterns may include event attendance, dining, and budget-conscious travel.

°Low Affluence: These are disciplined spenders with a focus on everyday essentials, such as groceries and fuel, while allocating limited discretionary spending to categories like travel and entertainment. This profile often maps to young to middle-aged individuals, early nesters, and tech-savvy users.

°Mass Market: This segment consists of price-sensitive consumers who primarily spend on household necessities and public transport. They are commonly located in rural and suburban areas with lower income levels and may include younger adults and middle-aged individuals residing in areas with lower housing costs.

In some implementations, this clustering process may be implemented in Python using libraries such as Scikit-learn, NumPy, and Pandas, and the outputs may be stored or provided to other modules of the system 100.

Referring specifically now to the segmentation module 106, as described, the segmentation module 106 may be configured to assign account holders to segments based on comparative transaction behavior. This may be achieved through a rule-based segmentation framework that uses predefined criteria, such as transaction frequency with both a target merchant (e.g., an airline carrier) and competing merchants.

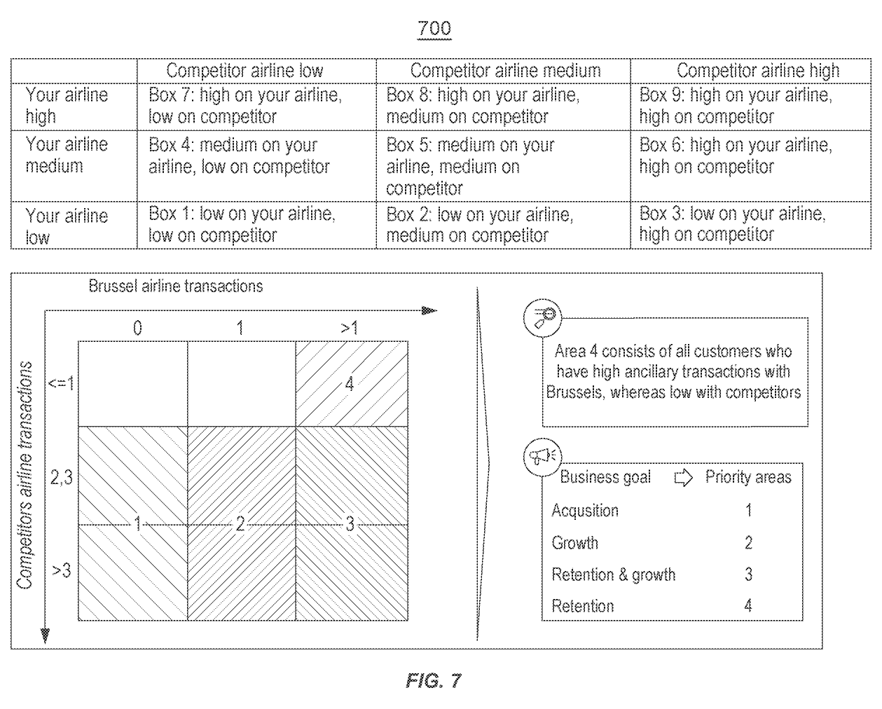

In some implementations, as illustrated in a table 700 of FIG. 7, the segmentation module 106 may implement a 9-box segmentation model in which account holders are classified along two axes: (i) transaction frequency with the target airline and (ii) transaction frequency with competitor airlines. Each axis may be divided into three discrete categories, high, medium, and low, resulting in a matrix of nine potential segment assignments. Each matrix cell (or box) corresponds to a different combination of behavior with the target and competitor brands.

For example, account holders who transact frequently with the target airline but infrequently with competitor airlines may be categorized into Box 7, indicating high loyalty and low competitor engagement. Conversely, account holders with low frequency on the target airline and high frequency on competitors may fall into Box 3, suggesting a high risk of defection or a competitor-aligned preference.

This segmentation enables the system 100 to tailor downstream strategies (e.g., targeting, rewards, or retention offers) based on a consumer’s position in the matrix. For instance, Box 4, which reflects medium frequency on the target airline and low frequency on competitors, may be prioritized for growth strategies. Meanwhile, Box 6 may warrant competitive win-back campaigns.

Referring specifically now to the transaction clustering module 104, as described, the market size extrapolation module 108 may be configured to estimate the total market opportunity associated with specific account holder segments or clusters identified by modules of the system 100. This estimation may begin by analyzing observed transaction data, such as airline spend data from a payment network like Mastercard®, segmented by account holder groups (e.g., SMEs, affluence tiers, mass market). Because such observed data reflects only a portion of the total market, the market size extrapolation module 108 may apply a series of adjustments to scale the transaction data to represent broader market activity. These adjustments may include accounting for the payment network’s market share (e.g., if Mastercard® accounts for 40% of card payments, the observed data may be scaled by 1/0.4), credit card penetration in the airline market (e.g., adjusting for the proportion of total payments made using cards versus other methods), and data coverage biases (e.g., correcting for geographic or demographic underrepresentation). Each of these adjustments may be performed independently for each segment or cluster to ensure accurate estimation across behavioral profiles. In some implementations, the market size extrapolation module 108 may compare extrapolated estimates with external benchmarks such as industry reports, government statistics, or competitor data to validate assumptions and refine scaling factors.

To help illustrate, FIG. 8 depicts consumer profiles across two dimensions, total market size (y-axis) and average airline spend per card (x-axis), with bubble size representing the relative population size of each profile. For example, as shown in FIG. 8, SME/business spenders may appear in the upper-right quadrant, reflecting both high total spend and large opportunity volume, while mass market and low-affluence groups may appear in lower-value quadrants. These insights may be provided and used by the targeting strategy generation module 114 to quantify headroom and prioritize engagement strategies across distinct customer types.

Referring specifically now to the affinity detection module 110, as described, the affinity detection module 110 may be configured to perform affinity analysis on transaction data to identify co-purchase patterns across merchant categories and brands. In some implementations, the affinity detection module 110 may analyze account holder transaction histories to determine which items, such as specific product categories or brands, tend to be purchased together within a given period. In some implementations, the analysis may be performed using the Apriori algorithm, which proceeds through the following stages: 1) the affinity detection module 110 may mine frequent itemsets by scanning transaction data to identify combinations of items (e.g., airline tickets and hotel stays) that exceed a specified minimum support threshold; and 2) the affinity detection module 110 may generate association rules from those itemsets, typically expressed as “If an account holder purchases item A, they are likely to purchase item B.” These rules may be evaluated using confidence (i.e., conditional probability) and optionally lift or conviction metrics to assess the significance and usefulness of the observed associations.

Based on the results, the affinity detection module 110 may derive actionable insights about customer preferences. For example, with reference to FIG. 9, the affinity detection module 110 may detect that SME travelers who purchase airline tickets often also transact with specific brands such as Hilton®, Radisson®, Hertz®, or Europcar®. These patterns may inform targeted promotions or product bundling strategies, for instance, encouraging airline customers to earn rewards or receive offers when transacting with partnered quick-service restaurants like Pret A Manger® or Starbucks®, or transportation services such as MTA or SNCF®. FIG. 9 visually illustrates these brand-level co-purchase affinities across categories such as vehicle rental, accommodation, restaurants, and railroad providers. For instance, account holders of the SME traveler segment may often book a Hilton® stay along with a Hertz® rental and train service via DB®.

Referring specifically now to the geo-location generation module 112, as described, the geo-location generation module 112 may be configured to infer an account holder’s likely residential region based on patterns in their transaction activity. In some implementations, to accomplish this, the geo-location generation module 112 may implement a technique that prioritizes transactions strongly correlated with residential behavior (such as those occurring at grocery stores, pharmacies, and fuel stations) to estimate a home zip code, province, or neighborhood cluster.

In some implementations, the geo-location generation module 112 may operate using a hierarchical ranking system that classifies transaction data into categories of descending reliability as proxies for residence. The highest priority may be assigned to a first tier of everyday transactions made in essential and residentially tied categories. These may include purchases at supermarkets, fuel stations, pharmacies, and convenience stores. If such data is unavailable or insufficient, the geo-location generation module 112 may default to a second tier of ATM transactions, which, although may be slightly less reliable, often may still reflect local patterns of use. In the absence of both, a third tier of other general point-of-sale (POS) transactions (such as retail or dining) may be used as a fallback, albeit with lower reliability due to their occurrence near workplaces or travel hubs.

Further, in implementing this hierarchical ranking system, the geo-location generation module 112 may receive transaction data tagged with merchant location (e.g., zip code), merchant category (e.g., grocery, pharmacy), transaction type (e.g., ATM withdrawal, everyday spend, POS purchase), and transaction timestamps and values. Further, payment transactions may first be extracted and categorized by type and merchant zip code and then aggregated for each account holder. Zip codes may be ranked within each category based on the number of transactions, recency, and frequency of spend.

The geo-location generation module 112 may then select the zip code with the highest rank within the highest available priority tier for that account holder. If no valid transactions exist in that tier, the process may cascade to the next lower tier, and so on. The geo-location generation module 112 may output an inferred residential zip code and a confidence score derived from transaction volume, recency, and category priority.

The results of the geo-location generation module 112 may be visualized in FIG. 10, where darker regions represent higher estimated concentrations of account holders’ residential locations. For example, FIG. 10 displays a regional concentration map highlighting zip codes with the highest weighted evidence of residence based on prioritized transaction behavior of the account holder. Such insights may support geo-targeted engagement strategies, personalized offers, or market sizing by region.

Referring specifically now to the targeted strategy generation module 114, as described, the targeted strategy generation module 114 may be configured to generate data configured to facilitate engagement between a target merchant and account holders associated. More specifically, this data may be configured to drive personalized marketing campaigns, loyalty initiatives, or contextual offers that are tailored to account holder behaviors, preferences, and inferred locations.

To support targeted engagement, the targeted strategy generation module 114 may leverage location insights, such as inferred residential regions generated by the geo-location generation module 112. The inferred locations may be used to identify where account holders are likely to live, work, and shop. In some implementations, the targeted strategy generation module 114 may further apply geofencing techniques to define virtual boundaries around key physical locations (e.g., stores, airports, or neighborhoods) and detect when an account holder enters or is near these areas. This may enable delivery of offers that are contextually timed and location aware. Still yet, in some implementations, the targeted strategy generation module 114 may also identify high-density geographic clusters with strong engagement or spend to prioritize targeting efforts.

In some implementations, the targeted strategy generation module 114 may further utilize brand and category preferences derived from the affinity detection module 110. For example, association rules may reveal that a particular segment of account holders frequently purchases airline tickets alongside hotel stays (e.g., Hilton®, Radisson®), vehicle rentals (e.g., Hertz®, Sixt®), or food and beverage brands (e.g., Pret A Manger®, Starbucks®). These insights may be used to tailor offers that reflect known preferences. Additionally, cross-selling opportunities may be surfaced, such as offering travel insurance or premium lounge access to account holders who frequently purchase airfare.

In some implementations, the targeted strategy generation module 114 may also incorporate past transaction history (e.g., provided by the transaction clustering module 104 and the segmentation module 106) to gauge account holder engagement and purchasing power. This may involve analyzing transaction frequency, recency, total volume, preferred purchase times, and transaction channels (e.g., online vs. offline). Seasonal or event-driven spikes in spending may also be identified to help time campaign delivery for maximum impact. By synthesizing geolocation, behavioral, and affinity insights, the targeted strategy generation module 114 may dynamically produce engagement data that supports timely, location-relevant, and personalized outreach to account holders within each segment.

Accordingly, in view of the implementations discussed above with respect to FIGS. 1-10, various implementations of a system and method for enabling or promoting engagement between merchants and consumers based on payment transaction data are described herein. The system described herein provides a number of technical and practical benefits through its ability to identify, classify, and engage account holders using transaction data. In some implementations, the system may identify, based on transaction data, payment transactions that are associated with predetermined merchants, merchant categories, and/or industries. This enables the system to isolate relevant consumer activities from broader payment datasets, facilitating targeted analysis of behaviors tied to specific sectors, such as airlines, hospitality, or retail.

Further, the system may identify, based on the identified payment transactions, one or more account holders associated with the identified payment transactions that exhibit predetermined transaction activity patterns corresponding to predefined consumer or business profiles. This enables more accurate classification of consumers, including identifying segments such as small business spenders, affluent travelers, or mass market consumers. Such classification can be performed with greater precision using behavioral signals inferred directly from transaction data rather than relying on static demographic assumptions.

Additionally, the system may classify the identified account holders into a plurality of segments based on transaction frequency with a target merchant. This segmentation enables the system to capture varying degrees of loyalty and engagement. For example, account holders may be categorized into high-, medium-, or low-frequency segments with respect to both the target merchant and its competitors, allowing for nuanced marketing strategies.

Finally, the system may generate data configured to facilitate engagement between the target merchant and account holders associated with a segment of the plurality of segments. This supports the generation of tailored promotional offers, loyalty incentives, or other contextually relevant outreach efforts. As a result, merchants may be able to drive increased retention, conversion, and customer value by delivering offers that are timely, location-aware, and personalized based on the user’s demonstrated behavior.

### Computing System

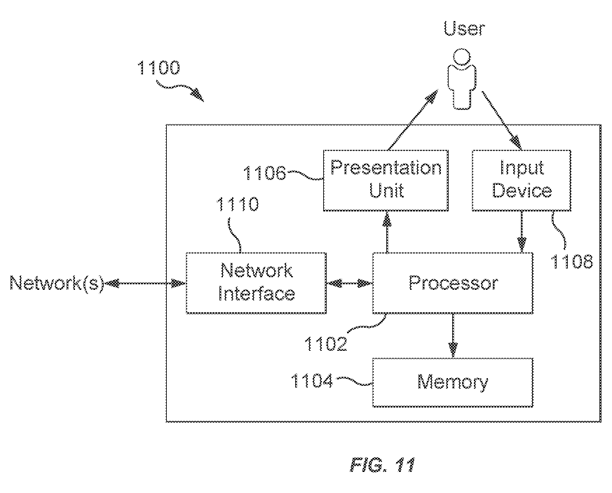

FIG. 11 illustrates a diagram of a computing system 1100 in which one or more various technologies described herein may be incorporated and practiced. The computing system 1100 may be any computing system known to those skilled in the art. For example, the computing system 1100 may include one or more servers, workstations, personal computers, laptops, tablets, smartphones, personal digital assistants (PDAs), and/or the like. In one implementation, the computing system 1100 may include a single computing system. In another implementation, the computing system 1100 may include multiple computing systems located in close proximity and/or distributed over a geographic region, where the computing systems may be configured to function as described herein.

The computing system 1100 can be used to implement one or more of the computing systems discussed above, such as the modules and systems 100, 102, 104, 106, 108, 110, 112, 114, 404, and 412. Those skilled in the art will understand that the computing system 1100 may use different computing systems and/or arrangements of computing systems than those described with respect to FIG. 11. In addition, different components and/or arrangements of components may be used in other computing systems.

Referring to FIG. 11, the computing system 1100 may include a processor 1102 and a memory 1104 coupled to and/or in communication with the processor 1102. The processor 1102 may include one or more processing units (e.g., in a multi-core configuration and/or the like). For example, the processor 1102 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 1104, as described herein, may include one or more devices that permit data, instructions, etc., to be stored therein and retrieved therefrom. The memory 1104 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 1104 may be configured to store, without limitation, images, private and/or public keys, public/private key pairs, identity records, certified and/or certification records, hashed data, signed data, one or more data structures, and/or other types of data suitable for use as described herein. Furthermore, in various implementations, computer-executable instructions may be stored in the memory 1104 for execution by the processor 1102 to cause the processor 1102 to perform one or more of the functions described herein, such that the memory 1104 may be a physical, tangible, and non-transitory computer readable storage media. Such instructions may be used to improve the efficiencies and/or performance of the processor 1102 and/or other computer system components configured to perform one or more of the various operations herein. It should be appreciated that the memory 1104 may include a variety of different memories, each implemented in one or more of the functions or processes described herein.

The computing system 1100 may also include a presentation unit 1106 that is coupled to and/or in communication with the processor 1102. However, it should be appreciated that the computing system 1100 could include output devices other than the presentation unit 1106 and/or the like. The presentation unit 1106 may output information to a user, such as by using a visual output. Further, one or more interfaces may be displayed at computing system 1100, including at presentation unit 1106, to display certain information. The one or more interfaces may be defined by the one or more applications mentioned above, defined by websites, defined by mobile applications, and/or the like. In addition, the one or more interfaces may be used to capture images of documents, capture selfies, capture biometrics, and/or the like. The presentation unit 1106 may include, without limitation, a liquid crystal display (LCD), a light-emitting diode (LED) display, an organic LED (OLED) display, an "electronic ink" display, speakers, and/or the like. In some implementations, the presentation unit 1106 may include multiple devices.

In addition, the computing system 1100 may include an input device 1108 configured to receive and/or acquire one or more inputs from a user (i.e., user inputs), such as in response to prompts from the one or more applications described above. The one or more inputs may include images of documents, images of a user (e.g., biometric data), and/or the like. The input device 1108 may include a single input device or multiple input devices. The input device 1108 may be coupled to and/or in communication with the processor 1102. The input device 1108 may include, for example, a keyboard, a pointing device, a mouse, a stylus, a camera, fingerprint scanner, a touch sensitive panel (e.g., a touch pad, a touch screen, and/or the like), acquisition equipment as described above, another computing system, an audio input device, or combinations thereof. In one implementation, a touch screen, such as that included in a tablet, a smartphone, or similar device, may behave as both a presentation unit and an input device. As mentioned above, the computing system may include and/or configured to be coupled to any equipment used to acquire one or more images of documents and/or biometric data. Such equipment may include a camera, a biometric sensor (e.g., fingerprint sensor, iris scanner, palm scanner, and/or the like), and/or any other device configured to acquire such data.

Further, the illustrated computing system 1100 may include a network interface 1110 coupled to and/or in communication with the processor 1102 and the memory 1104. The network interface 1110 may include, without limitation, a wired network adapter, a wireless network adapter (e.g., NFC adapter, a Bluetooth adapter, and/or the like), a mobile network adapter, and/or other devices capable of communicating to one or more different devices of the networks described herein. Further, in some implementations, the computing system 1100 may include the processor 1102 and one or more network interfaces incorporated into or with the processor 1102. In some implementations, the computing system 1100 may include global positioning system (GPS) capability, whereby the computing system 1100 may determine its current geographic location, perform mapping applications, and/or the like.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers’ specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method executed by at least one processor in communication with a memory, the method comprising:
identifying, based on transaction data, payment transactions that are associated with predetermined airline carriers or flight routes;
identifying, based on the identified payment transactions, one or more account holders associated with the identified payment transactions that exhibit predetermined payment transaction activity patterns corresponding to predetermined business-related spending;
classifying the identified account holders into a plurality of segments based on transaction frequency with a target airline carrier; and
generating, for a segment of the plurality of segments, data configured to facilitate engagement between the target airline carrier and account holders associated with the segment.

2. The method of claim 1, wherein identifying the payment transactions that are associated with the predetermined airline carriers or flight routes comprises:
extracting transaction features from the transaction data, the transaction features comprising characteristics indicative of airline carrier or flight route associations; and
classifying, using a machine learning model, the payment transactions as being associated with the predetermined airline carriers or flight routes based on the extracted transaction features.

3. The method of claim 2, further comprising:
training the machine learning model using a training data set comprising the transaction features and corresponding labels indicating associated airline carrier or flight route.

4. The method of claim 1, wherein identifying the one or more account holders associated with the identified payment transactions that exhibit predetermined payment transaction activity patterns corresponding to business-related spending comprises:
clustering, by transaction activity patterns, the one or more account holders associated with the identified payment transactions into a plurality of clusters; and
identifying one or more of the plurality of clusters that exhibit the transaction activity patterns corresponding to business-related spending.

5. The method of claim 1, further comprising:
extrapolating, for the segment, an estimated total payment transaction volume across a broader population of consumers sharing characteristics with account holders of the segment based on transaction data and market trend information associated with the account holders of the segment; and
generating, based on the estimated total payment transaction volume, the data configured to facilitate engagement between the target airline carrier and account holders associated with the segment.

6. The method of claim 1, further comprising:
analyzing transaction data associated with the segment to identify brands or product categories that are purchased by a same account holder within a predetermined temporal proximity to one another; and
generating, based on the identified brands or product categories, the data configured to facilitate engagement between the target airline carrier and account holders associated with the segment, wherein the data configured to facilitate engagement is further configured to indicate the identified brands or product categories.

7. The method of claim 1, further comprising:
analyzing transaction data associated with an account holder of the segment to identify recurring geographical locations corresponding to payment transactions made by the account holder;
determining, based on the recurring geographical locations, a residence region for the account holder; and
generating, based on the residence region, data configured to facilitate personalized engagement between the target airline carrier and the account holder.

8. A computer-implemented method executed by at least one processor in communication with a memory, the method comprising:
identifying, based on transaction data, payment transactions that are associated with a predetermined merchant, merchant category, or industry;
identifying, based on the identified payment transactions, one or more account holders associated with the identified payment transactions that exhibit a predetermined payment transaction activity pattern;
classifying the identified account holders into a plurality of segments based on transaction frequency with a target merchant; and
generating, for a segment of the plurality of segments, data configured to facilitate engagement between the target merchant and account holders associated with the segment.

9. The method of claim 8, wherein identifying payment transactions that are associated with predetermined associated with the predetermined merchant, merchant category, or industry comprises:
extracting transaction features from the transaction data, the transaction features comprising characteristics indicative of associations with the predetermined merchant, merchant category, or industry; and
classifying, using a machine learning model, the payment transactions as being associated with the predetermined merchant, merchant category, or industry based on the extracted transaction features.

10. The method of claim 9, further comprising:
training the machine learning model using a training data set comprising the transaction features and corresponding labels indicating associated merchant, merchant category, or industry.

11. The method of claim 8, wherein identifying the one or more account holders associated with the identified payment transactions that exhibit the predetermined payment transaction activity pattern comprises:
clustering the one or more account holders associated with the identified payment transactions into a plurality of clusters; and
identifying one or more of the plurality of clusters that exhibit the predetermined payment transaction activity pattern.

12. The method of claim 8, further comprising:
extrapolating, for the segment, an estimated total payment transaction volume across a broader population of consumers sharing characteristics with account holders of the segment based on transaction data and market trend information associated with the account holders of the segment; and
generating, based on the estimated total payment transaction volume, the data configured to facilitate engagement between the target merchant and account holders associated with the segment.

13. The method of claim 8, further comprising:
analyzing transaction data associated with the segment to identify brands or product categories that are purchased by a same account holder within a predetermined temporal proximity to one another; and
generating, based on the identified brands or product categories, the data configured to facilitate engagement between the target merchant and account holders associated with the segment, wherein the data configured to facilitate engagement is further configured to indicate the identified brands or product categories.

14. The method of claim 8, further comprising:
analyzing transaction data associated with an account holder of the segment to identify recurring geographical locations corresponding to payment transactions made by the account holder;
determining, based on the recurring geographical locations, a residence region for the account holder; and
generating, based on the residence region, data configured to facilitate personalized engagement between the target merchant and the account holder.

15. At least one non-transitory computer-readable storage media having computer-executable instructions embodied thereon, wherein when executed by an intermediary transaction processing system including at least one processor in communication with a memory, the computer-executable instructions cause the at least one processor to:
identify, based on transaction data, payment transactions that are associated with predetermined airline carriers or flight routes;
identify, based on the identified payment transactions, one or more account holders associated with the identified payment transactions that exhibit predetermined payment transaction activity patterns corresponding to predetermined business-related spending;
classify the identified account holders into a plurality of segments based on transaction frequency with a target airline carrier; and
generate, for a segment of the plurality of segments, data configured to facilitate engagement between the target airline carrier and account holders associated with the segment.

16. The at least one non-transitory computer-readable storage media of claim 15, wherein the computer-executable instructions further cause the at least one processor to:
extract transaction features from the transaction data, the transaction features comprising characteristics indicative of airline carrier or flight route associations; and
classify, using a machine learning model, the payment transactions as being associated with the predetermined airline carriers or flight routes based on the extracted transaction features.

17. The at least one non-transitory computer-readable storage media of claim 16, wherein the computer-executable instructions further cause the at least one processor to:
train the machine learning model using a training data set comprising the transaction features and corresponding labels indicating associated airline carrier or flight route.

18. The at least one non-transitory computer-readable storage media of claim 15, wherein the computer-executable instructions further cause the at least one processor to:
cluster, by transaction activity patterns, the one or more account holders associated with the identified payment transactions into a plurality of clusters; and
identify one or more of the plurality of clusters that exhibit the transaction activity patterns corresponding to business-related spending.

19. The at least one non-transitory computer-readable storage media of claim 15, wherein the computer-executable instructions further cause the at least one processor to:
extrapolate, for the segment, an estimated total payment transaction volume across a broader population of consumers sharing characteristics with account holders of the segment based on transaction data and market trend information associated with the account holders of the segment; and
generate, based on the estimated total payment transaction volume, the data configured to facilitate engagement between the target airline carrier and account holders associated with the segment.

20. The at least one non-transitory computer-readable storage media of claim 15, wherein the computer-executable instructions further cause the at least one processor to:
analyze transaction data associated with the segment to identify brands or product categories that are purchased by a same account holder within a predetermined temporal proximity to one another; and
generate, based on the identified brands or product categories, the data configured to facilitate engagement between the target airline carrier and account holders associated with the segment, wherein the data configured to facilitate engagement is further configured to indicate the identified brands or product categories.
